(19) United States
(12) Patent Application Publication
(10) Pub. No.: US 2018/0334100 A1
(43) Pub. Date: Nov. 22, 2018

(54) REAR VIEW DISPLAY IMAGE VIEW POSITIONING AND ZOOM EFFECT SYSTEM AND METHOD

(71) Applicant: Panasonic Automotive Systems Company of America, Division of Panasonic Corporation of North America, Peachtree City, GA (US)

(72) Inventor: MICHAEL DEAN TSCHIRHART, ANN ARBOR, MI (US)

(73) Assignee: Panasonic Automotive Systems Company of America, Division of Panasonic Corporation of North America

(21) Appl. No.: 15/984,632

(22) Filed: May 21, 2018

Related U.S. Application Data
(60) Provisional application No. 62/509,459, filed on May 22, 2017.

(51) Int. Cl. B60R 1/00; G01S 13/93; H04N 5/232; G08G 1/0962; H04N 7/18; G06K 9/00

(52) U.S. Cl. CPC B60R 1/00; G01S 13/931; H04N 5/23296; G08G 1/09626; H04N 7/183; G06K 9/00805; G08G 1/168; B60R 2300/8093; B60R 2300/301; B60R 2300/306; G01S 2013/9317; G01S 2013/9314; B60R 2300/101

(57) ABSTRACT

A motor vehicle includes a display screen viewable by a driver of the motor vehicle. A rearview camera captures images of a scene behind the motor vehicle. Means detects a location of an object behind the motor vehicle. An actuator is coupled to the rearview camera and changes a field of view of the rearview camera. An electronic processor is communicatively coupled to the display screen, the rearview camera, the detecting means, and the actuator. The electronic processor controls the actuator to change the field of view of the rearview camera dependent upon the detected location of the object behind the motor vehicle. The electronic processor presents on the display screen video content dependent upon the images captured by the rearview camera.

### CROSS-REFERENCE TO RELATED APPLICATION

This application claims benefit of U.S. Provisional Application No. 62/509,459 filed on May 22, 2017, which the disclosure of which is hereby incorporated by reference in its entirety for all purposes.

### FIELD OF THE INVENTION

The disclosure relates to rearview displays in a motor vehicle, and, more particularly, to display-based mirror substitute technologies.

### BACKGROUND OF THE INVENTION

Display-based mirror substitute technologies like intelligent rearview mirror system (IRMS) enable a range of desirable features and functions to the driver. However, standard rear-view mirror or static perspective imaging systems offer only fixed viewpoint perspectives that may be inadequate in many dynamic vehicle positioning situations (such as parking, etc.).

FIG. 1A illustrates a first vehicle 10 following a second vehicle 12 and being within the field of view 14 of a rearview camera 16 of the second vehicle 12. Both vehicles may be traveling in direction 18. FIG. 1B illustrates an example image of vehicle 10 that a driver of vehicle 12 sees in a rearview mirror 20 of the prior art. As is well known, rearview mirror 20 does not provide alternative angles or viewpoints, and it may be difficult or impossible to use rearview mirror 20 to view an object that is not directly behind vehicle 12, or to accurately estimate the distance to an object behind vehicle 12.

### SUMMARY

The present invention may provide an apparatus to display visual information to a driver. The invention provides a display-based alternative to the traditional mirror or remote viewing applications (e.g., IRMS).

The present invention may provide a visual display for remote viewing of objects (e.g., a rear-facing camera feed) in which certain view perspectives and/or visual characteristics of objects are altered or augmented based on properties of that object (e.g., distance, direction of movement, rate of change of distance).

In one embodiment, a live video feed image (or representational video image) of a standard rear (or other) view is presented in which the camera positional perspective view changes to focus/zoom on the closest object in the vehicle path to facilitate driver awareness of relative vehicle positioning (e.g., while parallel parking, etc.).

The system can employ radar, camera image processing, or other technologies to determine the proximity and position of the closest object. The system can employ mechanical, optical or digital image processing methods to focus and position the object image in the display system.

In another embodiment, a live video feed image (or representational video image) of a standard rear (or other) view is presented in which the camera perspective changes visual characteristics (color/highlight, size, etc.) to facilitate driver awareness of relative vehicle positioning (e.g., while parallel parking, etc.).

The system can employ radar, camera image processing or other technologies to determine the proximity and position of the closest object. The system can employ mechanical, optical or digital image processing methods to change visual characteristics of the object image in the display system.

In one embodiment, the invention comprises a motor vehicle including a display screen viewable by a driver of the motor vehicle. A rearview camera captures images of a scene behind the motor vehicle. Means detects a location of an object behind the motor vehicle. An actuator is coupled to the rearview camera and changes a field of view of the rearview camera. An electronic processor is communicatively coupled to the display screen, the rearview camera, the detecting means, and the actuator. The electronic processor controls the actuator to change the field of view of the rearview camera dependent upon the detected location of the object behind the motor vehicle. The electronic processor presents on the display screen video content dependent upon the images captured by the rearview camera.

In another embodiment, the invention comprises a motor vehicle including a display screen viewable by a driver of the motor vehicle. A rearview camera captures images of a scene behind the motor vehicle. Means detects a location of an object behind the motor vehicle. Means adjusts the rearview camera to change a field of view of the rearview camera. An electronic processor is communicatively coupled to the display screen, the rearview camera, the detecting means, and the adjusting means. The electronic processor controls the adjusting means to change the field of view of the rearview camera dependent upon the detected location of the object behind the motor vehicle. The electronic processor presents on the display screen video content dependent upon the images captured by the rearview camera.

In yet another embodiment, the invention comprises a motor vehicle including a display screen viewable by a driver of the motor vehicle. A rearview camera captures images of a scene behind the motor vehicle. Means detects a location of an object behind the motor vehicle. An electronic processor is communicatively coupled to the display screen, the rearview camera, and the detecting means. The electronic processor selects portions of the captured images dependent upon the detected location of the object behind the motor vehicle. The electronic processor presents on the display screen video content dependent upon the selected portions of the images captured by the rearview camera.

### BRIEF DESCRIPTION OF THE DRAWINGS

A better understanding of the present invention will be had upon reference to the following description in conjunction with the accompanying drawings.

FIG. 1A is an overhead diagram of a first vehicle following a second vehicle and being with the field of view of a rearview camera of the second vehicle.

FIG. 1B is an example scene that a driver sees in a rearview mirror of the prior art with another vehicle following his vehicle, as shown in FIG. 1A.

FIG. 2 is a block diagram of one embodiment of a rearview display arrangement of the present invention.

FIG. 3A is an overhead diagram of a first vehicle in reverse gear while parking and approaching a second vehicle that is parked.

FIG. 3B is an example scene that a driver sees in a rearview display of the present invention while parking as shown in FIG. 3A.

FIG. 4A is an overhead diagram of a vehicle in reverse gear while parking and an object is behind the vehicle and off to the side.

FIG. 4B is an example scene that a driver sees in a rearview display of the present invention while parking as shown in FIG. 4A.

FIG. 5 is a flow chart of a method of the present invention for providing a display in a motor vehicle.

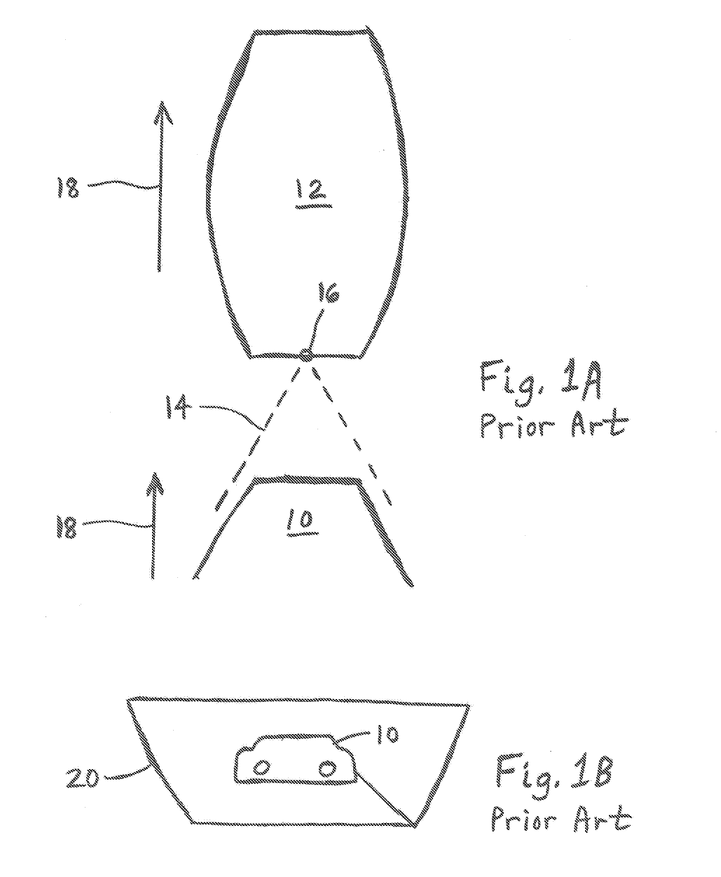

### DETAILED DESCRIPTION OF THE PREFERRED EMBODIMENTS

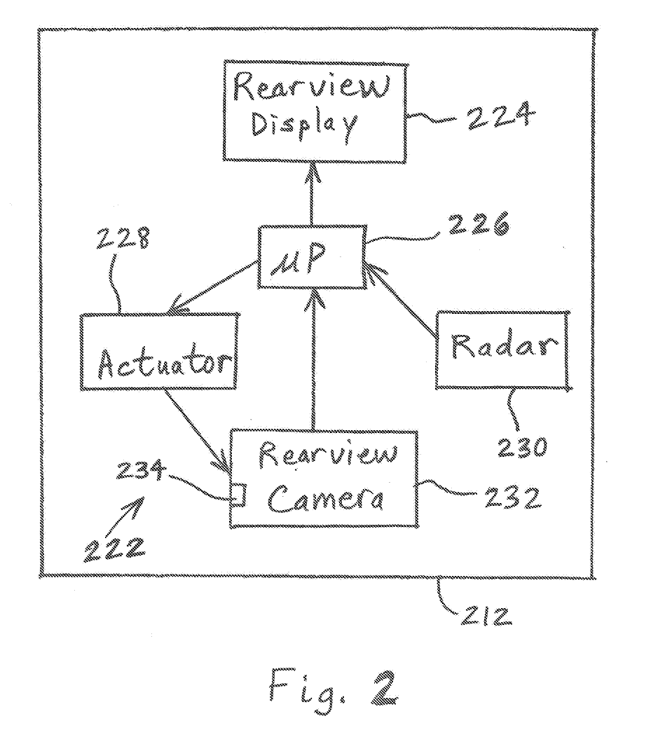

FIG. 2 illustrates one embodiment of a rearview display arrangement 222 of the present invention for a motor vehicle 212, including a rearview display screen 224, an electronic processor 226, an actuator 228, a radar system 230, and a rearview camera 232. Processor 226 may receive the images captured by camera 232 and present mirror images of the captured images on display screen 224. Mirror images of the captured images may be presented in order to emulate the view that a driver would see in a conventional mirror.

Rearview camera 232 may be attached to a rear end of vehicle 212, and may capture images of a scene behind the vehicle. Rearview camera 232 may have a field of view that is larger than the field of view of a conventional rearview mirror. For example, rearview camera 232 may be a hemispherical camera having a hemispherical field of view. However, processor 226 may present only a central portion of the captured image on display screen 224. Processor 226 may re-map the image for presentation on display screen 224 in order to remove any distortion created by a wide angle or hemispherical lens of camera 232.

Radar system 230 may detect the presence of objects near the rear end of vehicle 212, and may transmit a signal indicative of the location and size of the detected objects to processor 226. Alternatively, processor 226 may analyze the images captured by camera 212 and determine therefrom the location and size of objects near the rear end of vehicle 212.

Regardless of whether processor 226 ascertains the location of a nearby object from the signals from radar system 230 or from the images captured by camera 212, processor 226 may change the viewpoint of the images presented on display 224 in order to better display the nearby object. Processor 226 may change the viewpoint of the images presented on display 224 by physically moving camera 212 such that the images captured by camera 212 show more of the nearby object and/or show the nearby object from another angle that better illustrates the object. Processor 226 may control actuator 228, and actuator 228 may perform the movement of camera 212. For example, if it is determined that vehicle 212 is in reverse gear and is less than a predetermined distance from an object behind vehicle 212, such as during parking, then processor 226 may control actuator 228 to move camera 212 to point and be directed in a more downward direction in order to provide a better viewpoint for showing how far vehicle 212 is from the object.

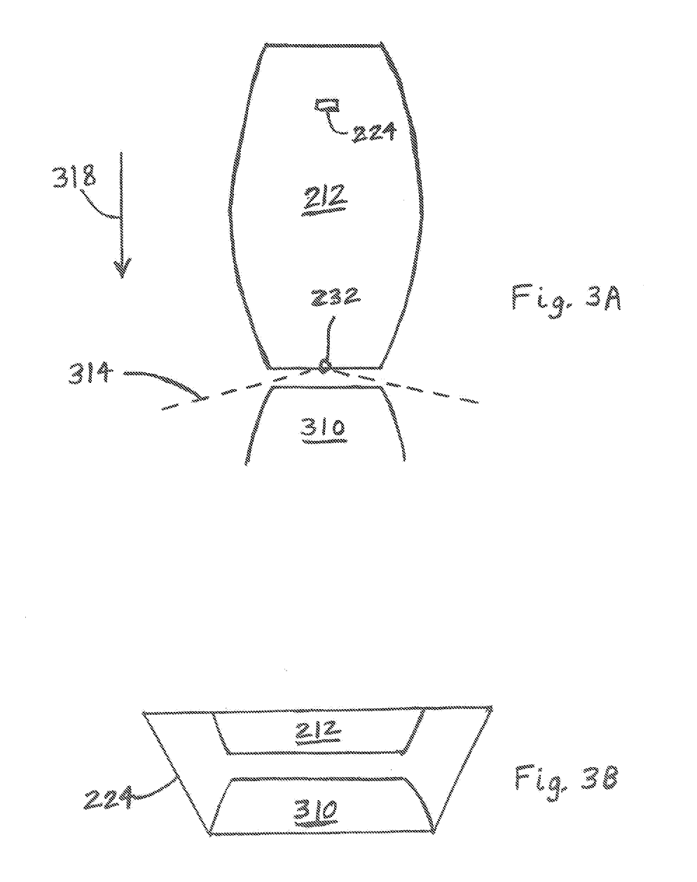

FIG. 3A illustrates vehicle 212 in reverse gear while parking and approaching an object in the form of a second vehicle 310 that is parked. Vehicle 310 may be within the field of view 314 of rearview camera 232 of the vehicle 212. Vehicle 212 may be traveling in a reverse direction 318. FIG. 3B illustrates an example image of a rear end of vehicle 212 and an end of vehicle 310. A driver of vehicle 212 may see this example image in rearview display screen 224 when vehicles 212, 310 are in the positions shown in FIG. 3A. That is, FIG. 3B is an example scene that a driver sees in a rearview display of the present invention while parking as shown in FIG. 3A. As can be determined from a comparison of FIGS. 3A and 3B, the image of FIG. 3B may be an enlargement or a zooming-in of the overhead view of FIG. 3A. This overhead view of FIG. 3B may be achieved by processor 226 controlling actuator 228 to move camera 232 so that its field of view 314 is in a more downward direction in order to provide a better viewpoint for showing how far vehicle 212 is from vehicle 310. Thus, rearview display arrangement 222 may enable a driver to use rearview display screen 224 to accurately estimate the distance to an object behind vehicle 212.

Alternatively, processor 226 may change the viewpoint of the images presented on display 224 by digitally modifying the portion of the captured images that is presented on display screen 224. The portion of the captured images that is presented on display screen 224 may be digitally modified such that the images captured by camera 212 show more of the nearby object. Processor 226 may change the portion of the captured images that is presented on display screen 224, or may enlarge or reduce the portion of the captured images that are presented on display screen 224. Regardless of the determined size of the portion of the captured images that are presented on screen 224, processor 226 may perform digital re-mapping of the image for presentation in order to remove distortions from the wide angle or hemispherical lens.

For example, if it is determined that vehicle 212 is in reverse gear, such as during parking, then processor 226 may search for nearby objects in the images captured by camera 212. Upon finding the nearest object of a threshold size in the captured images, processor 226 may select a portion of the captured images that includes the object for display on rearview display 224. That is, the displayed images may be centered on the nearby object, rather than being centered on the space directly behind vehicle 212. Thus, the driver may be provided a better viewpoint for seeing the object and monitoring how close vehicle 212 is getting to the object.

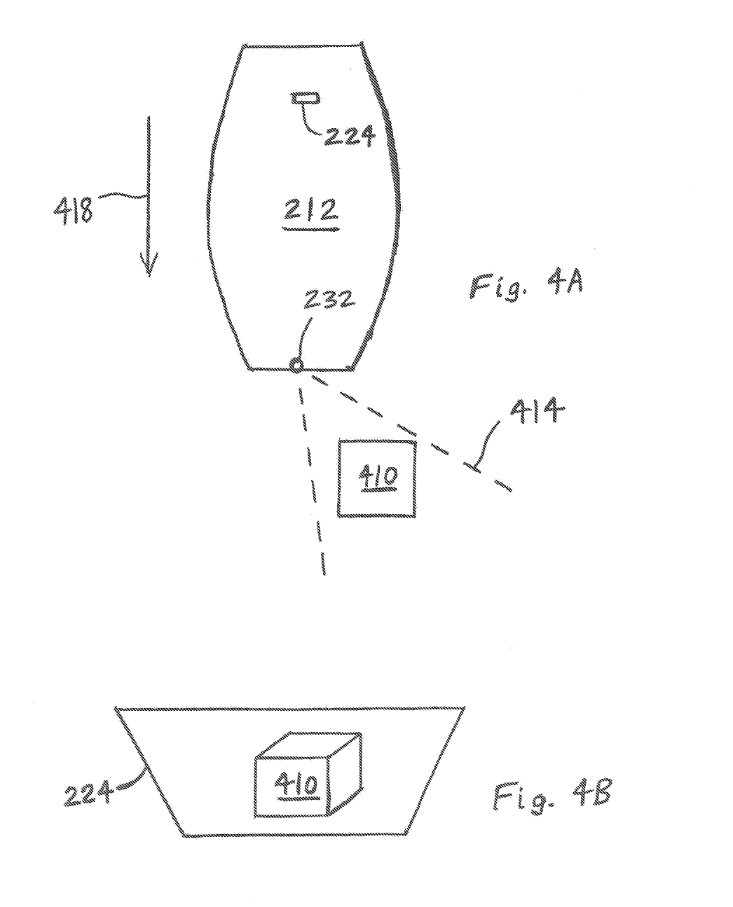

FIG. 4A illustrates vehicle 212 in reverse gear while parking and approaching an object 410 that is behind vehicle 212 and off to the side. Object 410 may be within the hemispherical field of view of rearview camera 232 of the vehicle 212. Vehicle 212 may be traveling in a reverse direction 318. After recognizing object 410 in the images captured by camera 232, or by detecting object 410 by use of radar 230, processor 226 may select a portion of the hemispherical field of view that includes an enlarged view of object 410. Processor 226 may perform remapping on the selected portion of the image in order to remove distortion from images captured by the hemispheric lens. As a result of such portion selection and remapping, images may be presented on rearview display 224 that reflect an effective field of view 414.

FIG. 4B illustrates an example image of object 410. A driver of vehicle 212 may see this example image in rearview display screen 224 when vehicle 212 and object 410 are in the positions shown in FIG. 4A. That is, FIG. 4B is an example scene that a driver sees in a rearview display of the present invention while parking as shown in FIG. 4A. Thus, rearview display arrangement 222 may enable a driver to use rearview display screen 224 to view an object that is not directly behind vehicle 212.

As another alternative, processor 226 may change the viewpoint of the images presented on display 224 by physically moving the lens or lenses of camera 212 to thereby change the field of view or the focus of camera 212 to better illustrate the nearby object. For example, processor 226 may use actuator 228 to change the distance between lenses 234 (FIG. 2) of camera 212 and thereby zoom in or zoom out on the images captured by camera 212.

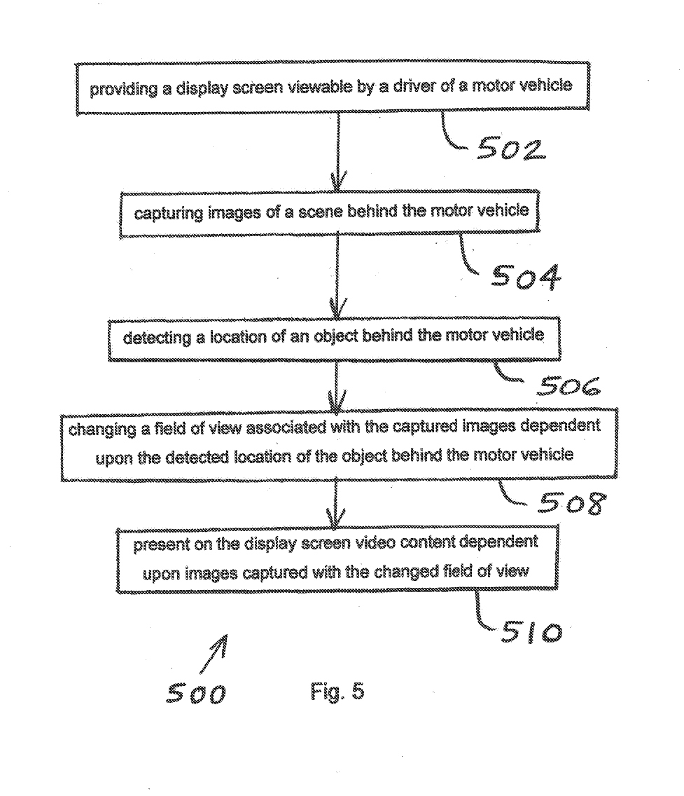

FIG. 5 illustrates a method of the present invention for providing a display in a motor vehicle. In a first step 502, a display screen viewable by a driver of the motor vehicle is provided. For example, a rearview display 224 viewable by a human driver may be permanently installed in vehicle 212.

In a next step 504, images of a scene behind the motor vehicle are captured. For example, a rearview camera 232 may be attached to a rear end of vehicle 212, and may capture images of a scene behind vehicle 212.

Next, in step 506, a location of an object behind the motor vehicle is detected. For example, processor 226 may search for and find a nearby objects in the images captured by camera 212.

In step 508, a field of view associated with the captured images is changed dependent upon the detected location of the object behind the motor vehicle. For example, the overhead view of FIG. 3B may be achieved by processor 226 controlling actuator 228 to move camera 232 so that its field of view 314 is in a more downward direction in order to provide a better viewpoint for showing how far vehicle 212 is from an object in the form of vehicle 310.

In a final step 510, video content is presented on the display screen dependent upon the images captured with the changed field of view. For example, processor 226 may present video content on rearview display 224 based on images captured by camera 232 after the field of view of camera 232 has been changed by actuator 228.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a display screen viewable by a driver of the motor vehicle;
a rearview camera configured to capture images of a scene behind the motor vehicle;
means for detecting a location of an object behind the motor vehicle;
an actuator coupled to the rearview camera configured to change a field of view of the rearview camera; and
an electronic processor communicatively coupled to the display screen, the rearview camera, the detecting means, and the actuator, the electronic processor being configured to:
control the actuator to change the field of view of the rearview camera dependent upon the detected location of the object behind the motor vehicle; and
present on the display screen video content dependent upon the images captured by the rearview camera.

2. The vehicle of claim 1 wherein the detecting means comprises a radar system.

3. The vehicle of claim 1 wherein the detecting means comprises the electronic processor being configured to analyze the captured images and identify the object in the captured images.

4. The vehicle of claim 1 wherein the actuator is configured to change a direction in which the rearview camera points.

5. The vehicle of claim 1 wherein the actuator is configured to move a lens of the rearview camera.

6. The vehicle of claim 1 wherein the electronic processor is configured to control the actuator to change the field of view of the rearview camera so that the object is substantially centered within the field of view and/or enlarged within the field of view.

7. The vehicle of claim 1 wherein the electronic processor is configured to present on the display screen video content with the object being substantially centered within the video content, the object being enlarged within the video content and/or the object being viewable from a downward viewpoint within the video content.

8. A motor vehicle, comprising:
a display screen viewable by a driver of the motor vehicle;
a rearview camera configured to capture images of a scene behind the motor vehicle;
means for detecting a location of an object behind the motor vehicle;
means for adjusting the rearview camera to change a field of view of the rearview camera; and
an electronic processor communicatively coupled to the display screen, the rearview camera, the detecting means, and the adjusting means, the electronic processor being configured to:
control the adjusting means to change the field of view of the rearview camera dependent upon the detected location of the object behind the motor vehicle; and
present on the display screen video content dependent upon the images captured by the rearview camera.

9. The vehicle of claim 8 wherein the detecting means comprises a radar system.

10. The vehicle of claim 8 wherein the detecting means comprises the electronic processor being configured to analyze the captured images and identify the object in the captured images.

11. The vehicle of claim 8 wherein the adjusting means is configured to change a direction in which the rearview camera points.

12. The vehicle of claim 8 wherein the adjusting means is configured to move a lens of the rearview camera.

13. The vehicle of claim 8 wherein the electronic processor is configured to control the adjusting means to change the field of view of the rearview camera so that the object is substantially centered within the field of view and/or enlarged within the field of view.

14. The vehicle of claim 8 wherein the electronic processor is configured to present on the display screen video content with the object being substantially centered within the video content, the object being enlarged within the video content and/or the object being viewable from a downward viewpoint within the video content.

15. A motor vehicle, comprising:
a display screen viewable by a driver of the motor vehicle;
a rearview camera configured to capture images of a scene behind the motor vehicle;
means for detecting a location of an object behind the motor vehicle; and
an electronic processor communicatively coupled to the display screen, the rearview camera, and the detecting means, the electronic processor being configured to:
select portions of the captured images, the selecting being dependent upon the detected location of the object behind the motor vehicle; and
present on the display screen video content dependent upon the selected portions of the images captured by the rearview camera.

16. The vehicle of claim 15 wherein the detecting means comprises a radar system.

17. The vehicle of claim 15 wherein the detecting means comprises the electronic processor being configured to analyze the captured images and identify the object in the captured images.

18. The vehicle of claim 15 wherein each said selected portion of the captured images is surrounded by an unselected portion of the captured images.

19. The vehicle of claim 15 wherein each said selected portion of the captured images is a noncentral portion of the captured images.

20. The vehicle of claim 15 wherein the electronic processor is configured to perform digital re-mapping of the selected portions of the captured images.

21. The vehicle of claim 15 wherein the electronic processor is configured to select portions of the captured images so that the object is substantially centered within the field of view and/or enlarged within the field of view.

22. The vehicle of claim 15 wherein the electronic processor is configured to select portions of the captured images such that the object is substantially centered within the video content, the object being enlarged within the video content and/or the object being viewable from a downward viewpoint within the video content.

23. The vehicle of claim 1 wherein the electronic processor is configured to code how the changed (e.g., magnified) view should influence the judgment/behavior of the driver, wherein the closer the obstacle the more sensitive/careful the driver might need to be with their steering/braking behavior, the vehicle further comprising an indicator enabling proper calibration with the system.

24. The vehicle of claim 1 wherein the electronic processor is configured to use a user-selectable variable as a basis for what view is presented.

25. The vehicle of claim 24, wherein the user-selectable variable is a distance from the vehicle to the object.

26. The vehicle of claim 24, wherein the user-selectable variable is a time rate of change of a distance from the vehicle to the object.

27. The vehicle of claim 8 wherein the adjusting means comprises zooming/cropping/selecting a digital image via any non-mechanical means.
